(19) United States
(12) Patent Application Publication
(10) Pub. No.: US 2006/0274186 A1
(43) Pub. Date: Dec. 7, 2006

(54) Lens focusing device with latching shoe

(76) Inventor: Akihiro Machida, Sunnyvale, CA (US)

Correspondence Address: AVAGO TECHNOLOGIES, LTD., P.O. BOX 1920, DENVER, CO, 80201-1920, US

(21) Appl. No.: 11/143,989

(22) Filed: Jun. 2, 2005

(51) Int. Cl. G02B 13/16

(52) U.S. Cl. 348/335

(57) ABSTRACT

A lens focusing device focuses lenses. A focusing mechanism is used to focus the lenses. A latching shoe, when engaged, holds the lenses in position. The latching shoe is engaged whenever power to the lens focusing device is off.

### BACKGROUND

Small digital cameras such as those placed in phones have very small lenses and mechanisms that control the lenses for focusing and zoom. A lens barrel is typically used to contain lenses. Magnets and/or magnetic coils are used to move lenses to and hold lenses in desired positions for focusing and zoom.

Holding lenses in position using magnetic coils requires a small though constant amount of power. For example, when using a magnetic coil to control position of the lenses, a constant current must be maintained in the magnetic coil to hold the lenses steady. However, small digital cameras are typically powered by batteries with limited storage capability. Holding lenses in a particular position can hasten draining of battery power and limit the amount of time the camera can be operated.

### SUMMARY OF THE INVENTION

In accordance with an embodiment of the present invention, a lens focusing device focuses lenses. A focusing mechanism is used to focus the lenses. A latching shoe, when engaged, holds the lenses in position. The latching shoe is engaged whenever power to the lens focusing device is off.

### BRIEF DESCRIPTION OF THE DRAWINGS

FIG. 1 shows a simplified cross-sectional illustration of an lens focusing device with a latching mechanism in a latched position in accordance with an embodiment of the present invention.

FIG. 2 shows a top view of the illustrated lens focusing device shown in FIG. 1, with the latching mechanism in the latched position in accordance with an embodiment of the present invention.

FIG. 3 shows a simplified cross-sectional illustration of the lens focusing device shown in FIG. 1 with the latching mechanism in an unlatched position in accordance with an embodiment of the present invention.

FIG. 4 shows a top view of the illustrated lens focusing device shown in FIG. 1, with the latching mechanism in the unlatched position in accordance with an embodiment of the present invention.

FIG. 5 shows a simplified cross-sectional illustration of the lens focusing device shown in FIG. 1 with the latching mechanism in the unlatched position after adjustment of the lens position in accordance with an embodiment of the present invention.

FIG. 6 shows a top view of the illustrated lens focusing device shown in FIG. 1, with the latching mechanism in the unlatched position in accordance with an embodiment of the present invention.

FIG. 7 shows a simplified cross-sectional illustration of the lens focusing device shown in FIG. 1 with the latching mechanism in the latched position in accordance with an embodiment of the present invention.

FIG. 8 shows a top view of the illustrated lens focusing device shown in FIG. 1, with the latching mechanism in the latched position in accordance with an embodiment of the present invention.

### DESCRIPTION OF THE EMBODIMENT

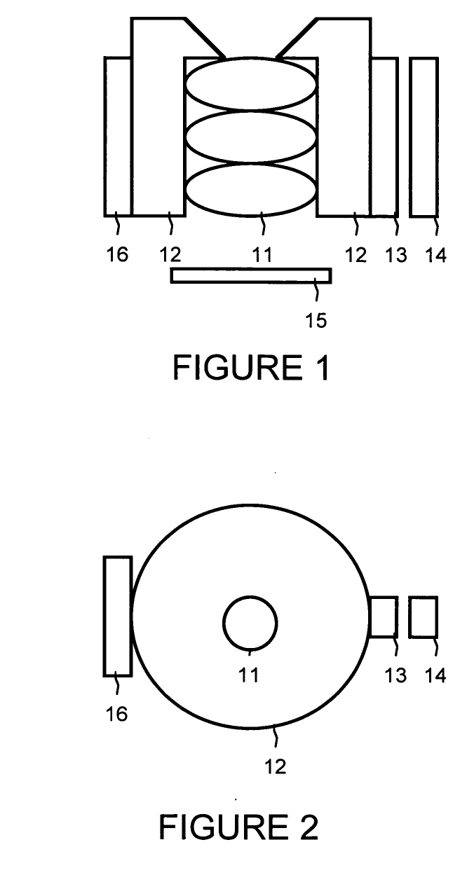

FIG. 1 shows a simplified cross-sectional illustration of a lens focusing device 10. For example, lens focusing device 10 is part of an auto focusing mechanism used in a small digital camera, such as those often included within a cell phone. Lenses 11 are held in position by a lens barrel 12. A magnetic coil 14, through magnetic influence exerted on a magnet 13 connected to lens barrel 12, is used to adjust the position of lens barrel 12 and thus control focus and zoom achieved by lenses 11. A sensor 15 is used to provide contrast feedback for controlling the positioning of lenses 11.

A latching shoe 16 is used to latch lens barrel 12 into desired positions. In FIG. 1, latching shoe 16 is shown engaged with lens barrel 12 in a latched position.

Latching shoe 16 is composed of material that is pressed again latch lens barrel 12 to hold latch lens barrel 12 in position. For example, latching shoe 16 is composed of an electro conductive polymer. Alternatively, latching shoe 16 is composed of one or more bimetal structure piezo electric plates. For example, latching show is controlled by applying voltage to the bimetal structure causing one of the piezo electric plates to elongate and the other of the piezo electric plates to contract.

FIG. 2 shows an illustrated top view of lens focusing device 10. As can be seen from FIG. 2, latching shoe 16 engages lens barrel 12 in a latched position.

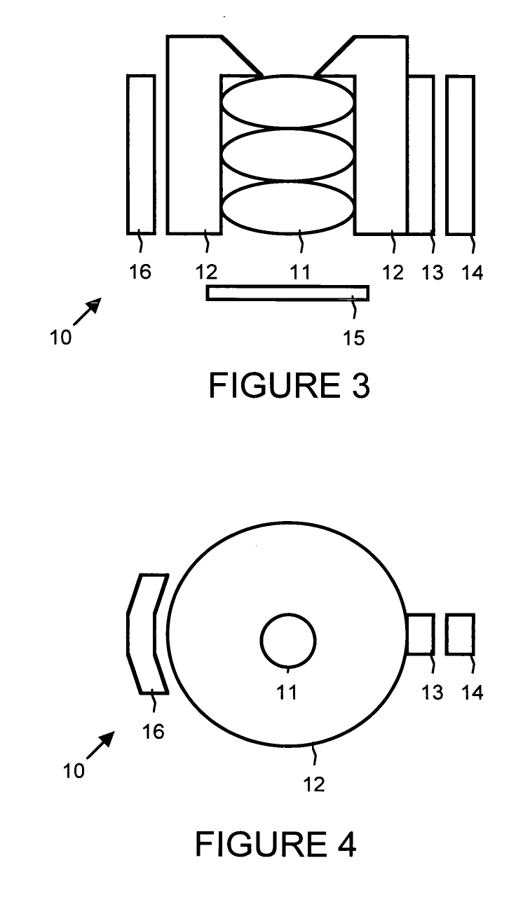

FIG. 3 shows another simplified cross-sectional illustration of lens focusing device 10. In FIG. 3, latching shoe 16 is shown disengaged from lens barrel 12 in an unlatched position.

FIG. 4 shows an illustrated top view of lens focusing device 10. As can be seen from FIG. 4, latching shoe 16 is disengaged from lens barrel 12 in an unlatched position.

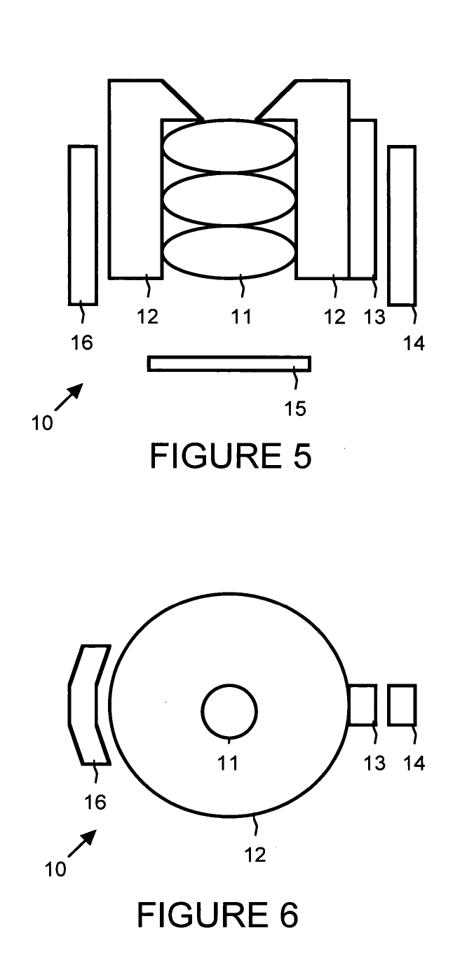

FIG. 5 shows another simplified cross-sectional illustration of lens focusing device 10. In FIG. 5, magnetic coil 14, through magnetic influence exerted on a magnet 13 connected to lens barrel 12, has adjusted the position of lens barrel 12 to vary focus and/or the zoom achieved by lenses 11. Sensor 15 provided feedback for controlling the positioning of lenses 11. As illustrated by FIG. 5, latching shoe 16 has remained disengaged from lens barrel 12 while the position of lens barrel was adjusted.

FIG. 6 shows an illustrated top view of lens focusing device 10. As can be seen from FIG. 6, latching shoe 16 remains disengaged from lens barrel 12 in an unlatched position.

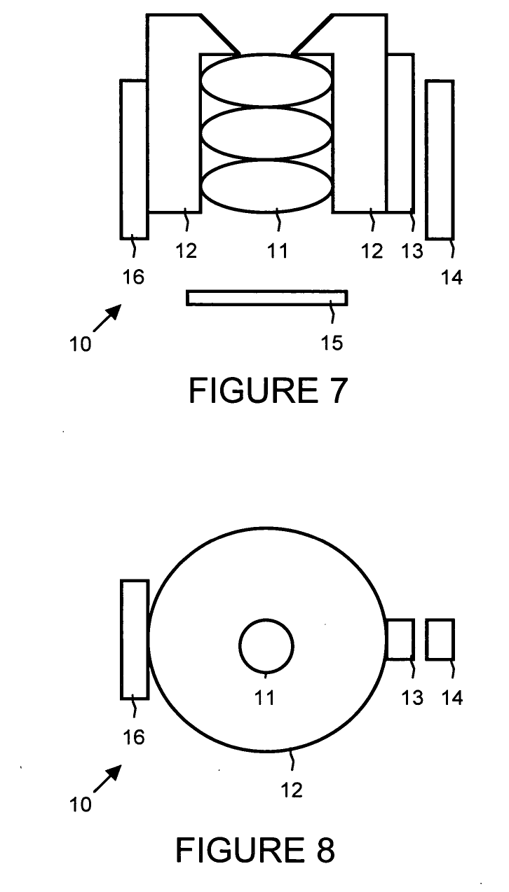

FIG. 7 shows another simplified cross-sectional illustration of lens focusing device 10. In FIG. 7, latching shoe 16 is shown engaged with lens barrel 12 maintaining the new position of lens barrel 12. This allows the new position of lens barrel 12 to be maintained even through current through magnetic coil 14 has been stopped.

FIG. 8 shows an illustrated top view of lens focusing device 10. As can be seen from FIG. 6, latching shoe 16 is now engaged with lens barrel 12 in a latched position.

The foregoing discussion discloses and describes merely exemplary methods and embodiments of the present invention. As will be understood by those familiar with the art, the invention may be embodied in other specific forms without departing from the spirit or essential characteristics thereof. Accordingly, the disclosure of the present invention is intended to be illustrative, but not limiting, of the scope of the invention, which is set forth in the following claims.

I claim:

1. A lens focusing device comprising:
lenses;
focusing mechanism that focuses the lenses; and,
a latching shoe that when engaged holds the lenses in position, wherein the latching shoe is engaged whenever power to the lens focusing device is off.

2. A lens focusing device as in claim 1 wherein the latching shoe is composed of an electro-conductive polymer.

3. A lens focusing device as in claim 1 wherein the latching shoe is composed of at least one piezo electric plate.

4. A lens focusing device as in claim 1 wherein the lens focusing device is an auto focusing device.

5. A lens focusing device as in claim 1 wherein the lens focusing device is part of a camera within a cellular phone.

6. A lens focusing device as in claim 1 wherein the lens focusing device is part of a digital camera.

7. A method for focusing lenses by a lens focusing device, the method comprising:
using a focusing mechanism to focus the lenses; and,
using a latching shoe to hold the lenses in position, including, engaging the latching shoe whenever power to the lens focusing device is off.

8. A method as in claim 7 wherein the latching shoe is composed of an electro-conductive polymer.

9. A method as in claim 7 wherein the latching shoe is composed of at least one piezo electric plate.

10. A method as in claim 7 wherein the lens focusing device is an auto focusing device.

11. A method as in claim 7 wherein the lens focusing device is part of a camera within a cellular phone.

12. A method as in claim 7 wherein the lens focusing device is part of a digital camera.

13. A lens focusing device comprising:
focusing means for focusing lenses; and,
latching means for holding the lenses in position whenever power to the lens focusing device is off, the latching means being composed of material that is pressed against a barrel structure that contains the lenses.

14. A lens focusing device as in claim 13 wherein the latching means is composed of an electro-conductive polymer.

15. A lens focusing device as in claim 13 wherein the latching means is composed of at least one piezo electric plate.

16. A lens focusing device as in claim 13 wherein the lens focusing device is an auto focusing device.

17. A lens focusing device as in claim 13 wherein the lens focusing device is part of a camera within a cellular phone.

18. A lens focusing device as in claim 13 wherein the lens focusing device is part of a digital camera.
